(19) United States
(12) Patent Application Publication
(10) Pub. No.: US 2020/0409188 A1
(43) Pub. Date: Dec. 31, 2020

(54) LIGHT MODULATION ELEMENT

(71) Applicant: SUMITOMO OSAKA CEMENT CO., LTD., Tokyo (JP)

(72) Inventors: Toshio Kataoka, Tokyo (JP); Tetsuya Fujino, Tokyo (JP); Masayuki Motoya, Tokyo (JP)

(21) Appl. No.: 16/497,920

(22) PCT Filed: Mar. 5, 2018
(86) PCT No.: PCT/JP2018/008349

§ 371 Date: Sep. 26, 2019

(30) Foreign Application Priority Data
Mar. 31, 2017 (JP) 2017-069819

(51) Int. Cl. G02F 1/035; G02F 1/03

(52) U.S. Cl. CPC G02F 1/035; G02F 1/0316

(57) ABSTRACT

In a light modulation element that modulates light by controlling light waves that propagate through an optical waveguide, the realization of the additional broadening of the bandwidth by improving the degree of freedom in the design of the electrode is enabled. A light modulation element which includes optical waveguides formed on a substrate and a control electrode and modulates light by controlling light waves that propagate through the optical waveguide by conducting electricity in the control electrode, in which the control electrode includes radio frequency electrodes that configure a signal line through which radio frequency signals propagate and a bias electrode to which a bias voltage is applied, and the radio frequency electrode has a conductive layer made of copper or a copper alloy.

### TECHNICAL FIELD

The present invention relates to a light modulation element that modulates light by controlling light waves that propagate through an optical waveguide and particularly to a light modulation element capable of improving the degree of freedom in the design of a control electrode that controls the light waves using radio frequency signals in a broad band.

### BACKGROUND ART

Recently, in the field of optical communication or optical measurement, optical waveguide-type light modulation elements having an optical waveguide disposed in a substrate having an electro-optic effect have been in broad use. Generally, the optical waveguide-type light modulation element includes a control electrode for controlling light waves that propagate through the optical waveguide together with the optical waveguide.

As such waveguide-type light modulation elements, for example, Mach-Zehnder-type light modulation elements in which lithium niobate (LiNbO₃) (also referred to as “LN”) that is a ferroelectric crystal is used for the substrate are in broad use. The Mach-Zehnder-type light modulation element includes a Mach-Zehnder-type optical waveguide. The Mach-Zehnder-type optical waveguide includes an input optical waveguide for introducing light waves from the outside and an optical branching unit for propagating light waves introduced through the input optical waveguide to two separate paths. In addition, the Mach-Zehnder-type optical waveguide has, behind the optical branching unit, two parallel optical waveguides that propagate the respective branched light waves and an output optical waveguide for multiplexing the light waves that have propagated through the two parallel optical waveguides and outputting the light waves to the outside. In addition, the Mach-Zehnder-type light modulation element includes a control electrode for controlling light waves by applying a voltage to change the phases of the light waves that propagate through the parallel optical waveguides using the electro-optic effect. Generally, the control electrode includes a signal electrode (radio frequency electrode) disposed in an upper portion or a vicinity of the parallel optical waveguides and a ground electrode disposed apart from the signal electrode and configures a signal line that propagates radio frequency signals at the same rate as the propagation rates of light waves in the parallel optical waveguides.

In the related art, as a material for the control electrode in the Mach-Zehnder-type light modulation element in which the LN substrate is used, gold (Au) is used from the viewpoint of the long-term stability of the material, bonding, and the like. Meanwhile, from the viewpoint of a light modulation operation carried out by propagating radio frequency signals through the signal line that the control electrode configures, the material desirably has a higher conductivity and a small conductor loss. That is, in order to broaden the bandwidth at a desired characteristic impedance by alleviating a trade-off limitation between the radio frequency propagation loss and the characteristic impedance in the control electrode, it becomes necessary to decrease the conductor loss of the control electrode.

Therefore, in the related art, the conductor loss is decreased by thickening the control electrode or broadening the width of a part of the control electrode to provide a mushroom-shaped cross section and thus increasing the cross-sectional area of the control electrode (refer to Patent Literature Nos. 1 and 2).

However, there is a limit on the degree of a decrease in the conductor loss that can be realized by an effort regarding the cross section or size of the control electrode, and it is desired to improve the degree of freedom in the design of the control electrode by further alleviating the trade-off limitation.

### CITATION LIST

### Patent Literature

[Patent Literature No. 1] Japanese Laid-open Patent Publication No. H1-91111

[Patent Literature No. 2] Japanese Laid-open Patent Publication No. H8-122722

### SUMMARY OF INVENTION

### Technical Problem

Due to the above-described background, in waveguide-type light modulation elements that modulate light by propagating radio frequency signals to a control electrode formed on an optical waveguide, it is desired to enable the realization of the additional broadening of the bandwidth by improving the degree of freedom in the design of the electrode.

### Solution to Problem

An aspect of the present invention is a light modulation element which includes an optical waveguide formed on a substrate and a control electrode and modulates light by controlling light waves that propagate through the optical waveguide by conducting electricity in the control electrode, in which the control electrode includes a radio frequency electrode that configures a signal line through which radio frequency signals propagate and a bias electrode to which a bias voltage is applied, and the radio frequency electrode has a conductive layer made of copper or a copper alloy.

According to another aspect of the present invention, on a part of an upper portion surface of the radio frequency electrode, a surface layer made of gold (Au) is formed.

According to another aspect of the present invention, the bias electrode does not include a conductive layer made of copper or a copper alloy.

Meanwhile, all of the contents of Japanese Patent Application No. 2017-069819 filed on Mar. 31, 2017 are regarded to be included in this specification.

### BRIEF DESCRIPTION OF DRAWINGS

FIG. 1 is a view showing a configuration of a light modulation element according to an embodiment of the present invention.

FIG. 2 is a cross-sectional view of the light modulation element shown in FIG. 1 in a direction of an arrow AA.

### DESCRIPTION OF EMBODIMENTS

Hereinafter, an embodiment of the present invention will be described with reference to the drawings.

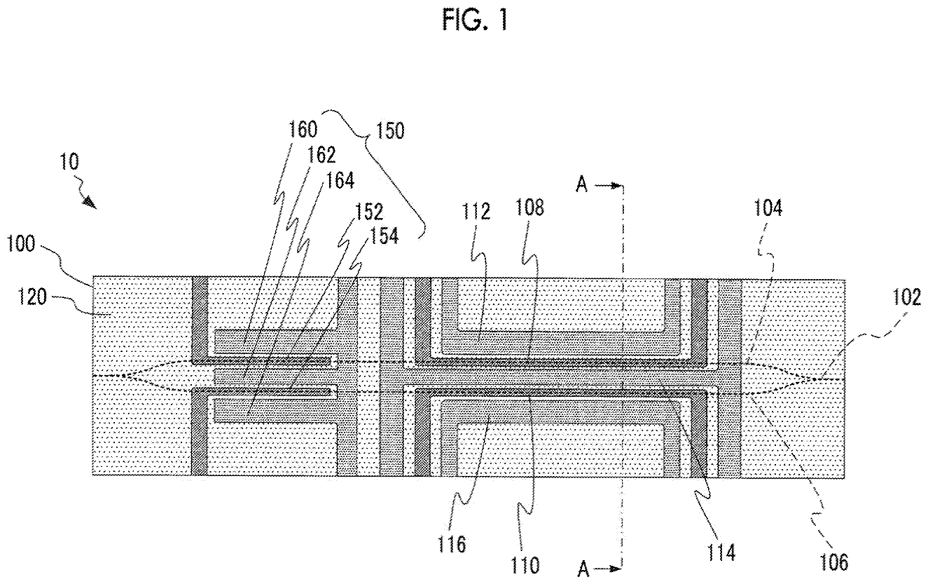

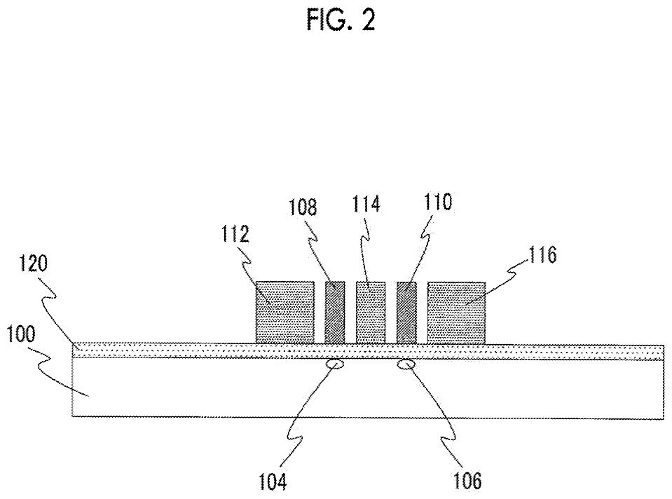

FIG. 1 is a view showing a configuration of a light modulation element according to an embodiment of the present invention. In addition, FIG. 2 is a cross-sectional view of the light modulation element shown in FIG. 1 in a direction of an arrow AA. The present light modulation element 10 is a Mach-Zehnder-type light modulation element having a Mach-Zehnder (MZ)-type optical waveguide 102 disposed on a substrate 100.

The substrate 100 is a substrate made of lithium niobate (LN) having an electro-optic effect and is, for example, a Z-cut LN substrate. On the substrate 100, a non-conductive layer 120 made of a non-conductive material is disposed. As the non-conductive layer 120, for example, a so-called buffer layer can be used. Such a buffer layer is provided for the purpose of avoiding the generation of an optical loss attributed to the absorption of light waves that propagate through an MZ-type optical waveguide 102 by an electrode 108 described below or the like and the like and is made of, for example, a material having a lower dielectric constant than the substrate 100 (specific materials will be described below).

The MZ-type optical waveguide 102 has parallel optical waveguides 104 and 106. Radio frequency (RF) electrodes 108 and 110 are respectively disposed along the parallel optical waveguides 104 and 106 right above the parallel optical waveguides 104 and 106. In addition, ground electrodes 112, 114, and 116 are disposed apart from the respective RF electrodes 108 and 110 by predetermined separation distances so as to clamp the RF electrodes 108 and 110. Radio frequency signals for controlling light waves that propagate through the parallel optical waveguides 104 and 106 are respectively applied between the RF electrode 108 and the ground electrodes 112 and 114 and between the RF electrode 110 and the ground electrodes 114 and 116. Light waves input from a shown left end of the MZ-type optical waveguide 102 are modulated (for example, modulated in intensity) by these radio frequency signals and outputted from a shown right end.

In addition, on the substrate 100, a bias electrode 150 that is a control electrode for controlling the difference in refractive index between the parallel optical waveguides 104 and 106 by applying electric fields to the two parallel optical waveguides 104 and 106 respectively is disposed. The bias electrode 150 includes operation electrodes 152 and 154 and reference electrodes 160, 162, and 164. The operation electrodes 152 and 154 are disposed along the parallel optical waveguides 104 and 106 respectively right above the parallel optical waveguides 104 and 106. In addition, the reference electrodes 160, 162, and 164 are provided apart from the operation electrodes 152 and 154 by predetermined separation distances so as to clamp the operation electrodes 152 and 154. A potential that serves as a reference is applied to the reference electrodes 160, 162, and 164, and a positive voltage or a negative voltage that serves as the reference is applied to the operation electrodes 152 and 154.

The bias electrode 150 compensates for a fluctuation in light modulation characteristics caused by a so-called DC drift phenomenon or temperature drift phenomenon. That is, in a case where the drift phenomenon causes a fluctuation (voltage shift) in light output-voltage characteristics during a light modulation operation in which the RF electrodes 108 and 110 are used, a voltage (bias voltage) is applied between the reference electrodes 160, 162, and 164 and the operation electrodes 152 and 154, whereby a difference in refractive index is generated between the parallel optical waveguides 104 and 106, and the voltage shift amount is compensated for.

Particularly, in the light modulation element 10 of the present embodiment, as a material of the RF electrodes 108 and 110 and the ground electrodes 112, 114, and 116 disposed apart from the RF electrodes 108 and 110, which configure the radio frequency signal lines, copper (Cu) is used. Therefore, in the light modulation element 10, the electric conductivity of copper configuring the RF electrodes 108 and 110 and the ground electrodes 112, 114, and 116 is higher than that of gold (Au) used in the related art, and thus the conductor loss in the radio frequency signal lines that the RF electrode 108 and the like configure is effectively decreased. This decrease in the conductor loss alleviates the trade-off limitation between the radio frequency propagation loss and the characteristic impedance in the signal lines that the RF electrode 108 and the like configure (that is, improves the degree of freedom in the design of the RF electrodes 108 and 110 and the ground electrodes 112, 114, and 116 which configure the signal lines) and facilitates the additional broadening of the bandwidth at a desired characteristic impedance.

In addition, particularly, in the light modulation element 10 of the present embodiment, the reference electrodes 160, 162, and 164 and the operation electrodes 152 and 154 which configure the bias electrode 150 are, unlike the RF electrode 108 and the like which configure the signal lines, made of gold (Au).

Generally, there is a possibility that the electric field that is applied between the reference electrodes 160, 162, and 164 and the operation electrodes 152 and 154 in the bias electrode 150 may be as great as approximately 5.0×10⁵ V/m and may become a maximum of approximately 4.0×10⁶ V/m. In such a case, when these electrodes configuring the bias electrode 150 are made of copper (Cu), copper ions migrate from any electrode on a low potential side along the surface of the substrate 100 (along the surface of the non-conductive layer 120 in the present embodiment), and so-called electromigration can occur. When such electromigration occurs, the migrated copper ions successively precipitate copper on the surface of the substrate 100 or the non-conductive layer 120, and a short-circuit path attributed to the precipitated copper can be formed between a low potential-side electrode and a high potential-side electrode.

Therefore, in the light modulation element 10 of the present embodiment, the reference electrodes 160, 162, and 164 and the operation electrodes 152 and 154 which configure the bias electrode 150 are made of not copper (Cu) that is used for the RF electrode 108 and the like which configure the radio frequency signal lines but gold (Au) that becomes more stable over time and does not easily cause electromigration.

Due to the above-described configuration, the light modulation element 10 is capable of additionally broadening the bandwidth at a desired characteristic impedance by improving the degree of freedom in the design of the RF electrodes 108 and 110 and the ground electrodes 112, 114, and 116 which configure the radio frequency signal lines and ensuring high reliability by decreasing the possibility of copper migration.

Meanwhile, in the present embodiment, the RF electrodes 108 and 110 and the ground electrodes 112, 114, and 116 which configure the signal lines are made of copper (Cu), but the material is not limited to copper, and the electrodes may be made of a copper alloy. As the copper alloy, for example, an Al—Cu alloy, a Ni—Cu alloy, a Be—Cu alloy, or a Sn—Cu alloy can be used.

In addition, each of the RF electrodes 108 and 110 and the ground electrodes 112, 114, and 116 which configure the signal lines does not need to be made of copper (Cu) in its entirety, and each of the electrodes may include at least a conductive layer made of copper (Cu) or a copper alloy.

In addition, in the present embodiment, the reference electrodes 160, 162, and 164 and the operation electrodes 152 and 154 which configure the bias electrode 150 are made of gold (Au), but the material is not limited to gold. The reference electrodes 160, 162, and 164 and the operation electrodes 152 and 154 can be made of an arbitrary metal (for example, silver (Ag)) as long as the electrodes do not include a conductive layer made of copper (Cu) or a copper alloy that causes electromigration.

In addition, in the case of carrying out wire bonding (for example, the bonding of a gold wire) on copper configuring the RF electrode 108 and the like, it can become difficult to realize the bonding intensity on a practical level. In such a case, it is possible to provide a surface layer made of gold (Au) on a part of the upper portion surface of the RF electrodes 108 and 110 and the ground electrodes 112, 114, and 116 which includes a conductive layer made of copper (Cu) or a copper alloy and configure the signal lines. Therefore, it becomes possible to carry out highly reliable wire bonding using the surface layer.

Meanwhile, in the present embodiment, as an example, the light modulation element 10 configured on the substrate 100 that is an LN substrate has been described, but the applicable range of the configuration of the RF electrode 108 and the like or the bias electrode 150 described in the present embodiment is not limited to light modulation elements in which an LN substrate is used. The above-described configuration of the RF electrode 108 and the like or the bias electrode 150 can be applied in the same manner to light modulation elements in which other materials having an electro-optic effect (for example, LiTaO₃, SrTiO₃, SrBi₂Ta₂O₉, BaTiO₃, KTiOPO₄, and PLZT) are used as a substrate or light modulation elements in which a semiconductor substrate that modulates light by controlling the refractive index of an optical waveguide by current injection is used.

### REFERENCE SIGNS LIST

10 . . . LIGHT MODULATION ELEMENT, 100 . . . SUBSTRATE, 102 . . . MZ-TYPE OPTICAL WAVEGUIDE, 104, 106 . . . PARALLEL OPTICAL WAVEGUIDE, 108, 110 . . . RF ELECTRODE, 112, 114, 116 . . . GROUND ELECTRODE, 120 . . . NON-CONDUCTIVE LAYER, 150 . . . BIAS ELECTRODE, 152, 154 . . . OPERATION ELECRODE, 160, 162, 164 . . . REFERENCE ELECRODE

1. A light modulation element comprising:
an optical waveguide formed on a substrate; and
a control electrode,
the light modulation element modulating light by controlling light waves that propagate through the optical waveguide by conducting electricity in the control electrode,
wherein the control electrode comprises a radio frequency electrode that configures a signal line through which radio frequency signals propagate and a bias electrode to which a bias voltage is applied, and
the radio frequency electrode has a conductive layer made of copper or a copper alloy.

2. The light modulation element according to claim 1,
wherein a surface layer made of gold (Au) is formed on a part of an upper portion surface of the radio frequency electrode.

3. The light modulation element according to claim 1,
wherein the bias electrode does not include a conductive layer made of copper or a copper alloy.

4. The light modulation element according to claim 2,
wherein the bias electrode does not include a conductive layer made of copper or a copper alloy.
